(19) United States
(12) Patent Application Publication
(10) Pub. No.: US 2018/0366871 A1
(43) Pub. Date: Dec. 20, 2018

(54) SOCKET STRUCTURE

(71) Applicant: Pei-Lin HUANG, New Taipei City (TW)

(72) Inventor: Pei-Lin HUANG, New Taipei City (TW)

(21) Appl. No.: 16/007,491

(22) Filed: Jun. 13, 2018

(30) Foreign Application Priority Data
Jun. 14, 2017 (TW) 106119885

(51) Int. Cl. H01R 13/627; H01R 13/11

(52) U.S. Cl. CPC H01R 13/6272; H01R 2103/00; H01R 13/11

(57) ABSTRACT

A socket structure is disclosed, comprising a base seat combined with an external cover, in which the top plane of the external cover has a socket panel, and a high-low tilted positioning plate is installed inside the external cover, with a high edge of the positioning plate being abutted by a movable abutting element, and the bottom end of the abutting element includes an elastic body; also, a release element is placed between the socket panel and the positioning plate, and the abutting element can be driven to move by means of a push button control located on one side of the socket panel.

### BACKGROUND OF THE INVENTION

### 1. Field of the Invention

The present invention generally relates to a socket structure; in particular, it relates to a socket structure capable of preventing electric power plugs from dropping off.

### 2. Description of Related Art

Typically, upon using a general electrical appliance, when a power plug is inserted into a socket and powered up, whether the power plug will fall off or not relies on the tightness difference clamped between the plug plates and the conductive copper plates installed inside the socket holes. However, once this plug insertion mating loosens, if an external pulling force does inadvertently occur, it may pull out the entire plug and cause the plug to fall off from the socket thus leading to power supply interruptions.

Additionally, in case that the plug inserted in the socket is affected by an external force and starts to loosen, it may potentially cause a dangerous situation of accidental electric shock. Therefore, how to make the plug stably inserted within the socket holes and not easily falling off from the socket because of such external forces become the current problem to be solved.

Accordingly, the present invention would be an optimal solution suppose it is possible to devise a socket structure capable of abutting the plug so as to prevent the plug from being pulled out after the plug is inserted into the socket holes thereby overcoming the aforementioned dangerous situations of power-off and accidental electric shock.

### SUMMARY OF THE INVENTION

The present invention discloses a socket structure capable of preventing electric power plugs from dropping off.

A socket structure is disclosed, comprising: an external cover, having a socket panel and a case of an outer frame plane, in which a ring-shaped groove is formed between the socket panel and the outer frame plane, and the socket plane includes a fire wire insertion hole, an earth wire insertion hole and a neutral wire insertion hole; a positioning plate, installed inside the outer cover in a high-low inclination configuration, in which the two ends thereof respectively form a high edge and a low edge such that, when the positioning plate is in an inclination state, the neutral wire power insertion prong of an electric power plug can be fixedly snapped, while, in a horizontal state, the neutral wire power insertion prong can be released from the inside of the positioning plate; a release element, with one end thereof abutting the inner wall plane of the socket panel, while the other end abutting the surface of the high edge on the positioning plate, and exhibiting a state of elastic force storage; a base seat, including a live wire power jack, an earth wire power jack and a neutral wire power jack, in which the socket seat can be combined with the external cover such that the live wire power jack, the earth wire power jack and the neutral wire power jack respectively correspond to the live wire insertion hole, the earth wire insertion hole and the neutral wire insertion hole on the socket panel, and a combination space is configured on the base seat; an abutting element, in which an upward inclined plane is configured on one side near the bottom end of the abutting element, and an elastic body is combined with the bottom end; the abutting element can be jointed to the combination space in the base seat such that the other end of the elastic body abuts the base seat, while the top end of the abutting element abuts the high edge of the positioning plate, so that the positioning plate demonstrates a high-low inclination configuration due to such abutments by means of the abutting element; additionally, the elastic force in the elastic body is greater than the release element; a control element fixation structure, which includes a standing plate, and a control stage is set up on the standing plate and has a push button movement slot; in which the standing plate is fixedly connected to the base seat such that the control element fixation structure can be firmly placed on one side of the base seat and accordingly the control stage is located on one side of the outer frame plane in the external cover, and also one end of the push button movement slot indicates a lockup position, while the other end a release position; a control element, in which the top end thereof is a push button, a slide block is installed on one side of the bottom end, the bottom plane of the slide block has a downward inclined face which is inclined-plane-reversely configured with respect to the bottom plane of the abutting element; and the control element is combined onto the control element fixation structure such that the push button is located within the push button movement slot while the inclined face of the slide block can movably cling to the inclined plane on the bottom end of the abutting element; accordingly, when the push button moves, the inclined face at the bottom end of the push button can move on the inclined plane at the bottom end of the abutting element, and since such two inclined plane/face are reversely installed with respect to each other, the abutting element can move down a course due to the movement of the push button as well as the guidance from the inclined face.

In an embodiment, an accommodation groove extends from the inner wall of the socket panel and connected to the neutral wire insertion hole, and the length and width of the accommodation groove are both greater than the neutral wire insertion hole; also, a corresponding first inclined block extends respectively from the farthest edge of the bottom part on the long sidewall plane close to the neutral wire insertion hole, and a corresponding second inclined block respectively extends from the long sidewall plane on the other side remote from the neutral wire insertion hole, and the length that the first inclined block extends downwards from the socket panel is smaller than the second inclined block; and the accommodation groove is mainly for accommodating the positioning plate in order to make the positioning plate exhibit a high-low inclination state by means of the first inclined block and the second inclined block.

In an embodiment, a stopper extends from the short sidewall plane close to the neutral wire insertion hole, the end plane of the stopper remote from the socket panel is an inclined plane, and the stopper is located between the two first inclined blocks.

In an embodiment, the positioning plate is made of a metallic material, with an opening configured thereon, and the opening is eccentrically configured and corresponds to the neutral wire insertion hole.

In an embodiment, the release element is a spring or an elastic plate or rubber elastic body or plastic elastic body.

In an embodiment, the base seat includes a base stage, and the base stage is connected in communication with the combination space such that one end of the elastic body can abut the base stage.

In an embodiment, the elastic body is a spring, an elastic plate or rubber elastic body or plastic elastic body.

In an embodiment, the control element fixation structure and the base seat are integrally manufactured.

### BRIEF DESCRIPTION OF THE DRAWINGS

FIG. 1 shows a stereo disassembly view of the socket structure according to the present invention.

FIG. 2 shows a stereo assembly view of the socket structure according to the present invention.

FIG. 3A shows a local cross-section view of the socket structure according to the present invention.

FIG. 3B shows a local cross-section view of the socket structure according to the present invention.

FIG. 3C shows a local cross-section view of the socket structure according to the present invention.

FIGS. 4A and 4B show views for the electric power socket, in the lockup state, of the socket structure according to the present invention.

FIGS. 5A and 5B show views for the electric power socket, in the release state, of the socket structure according to the present invention.

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

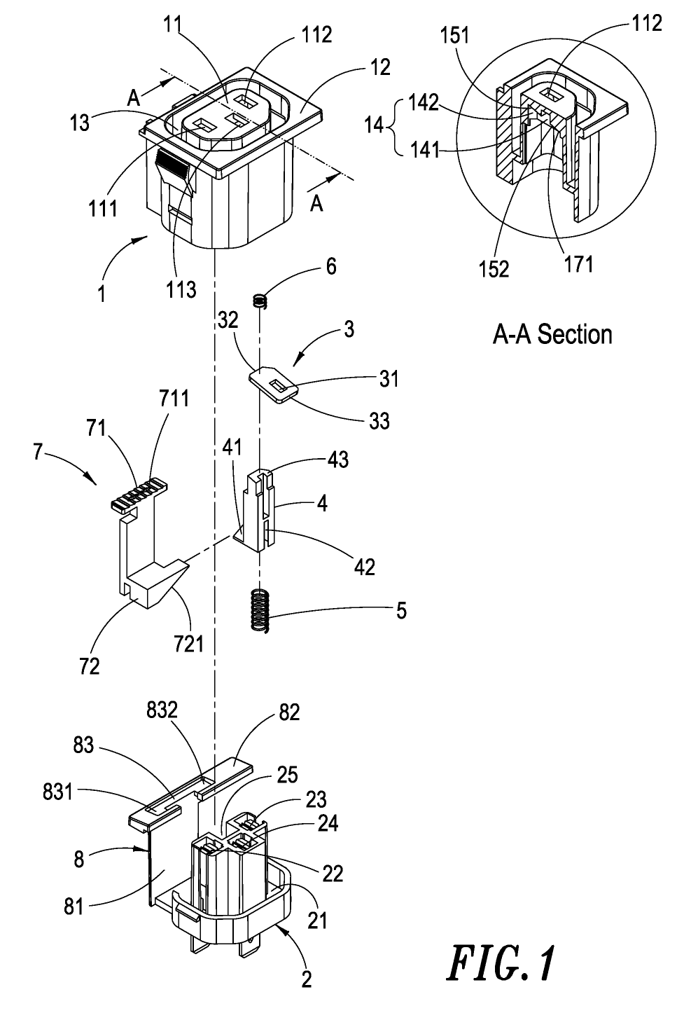

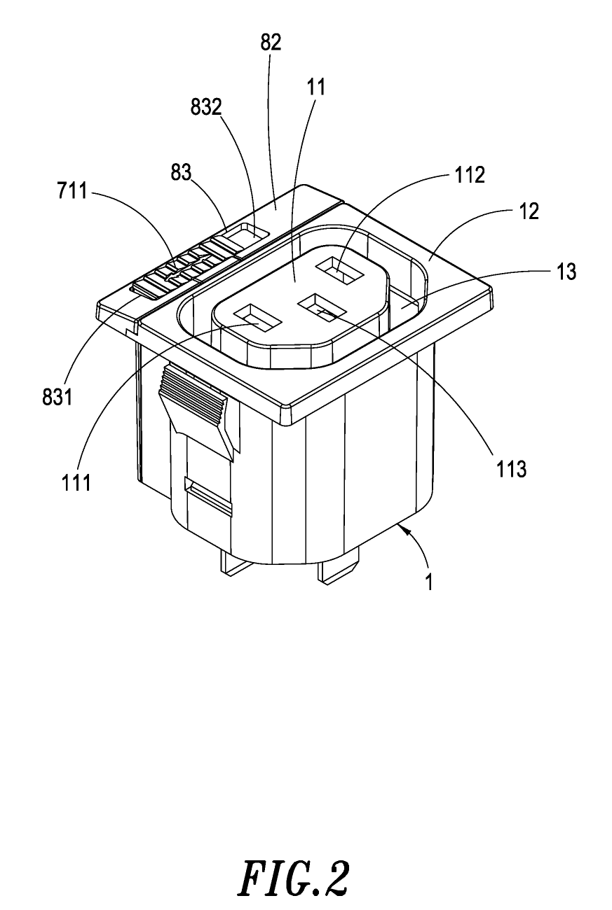

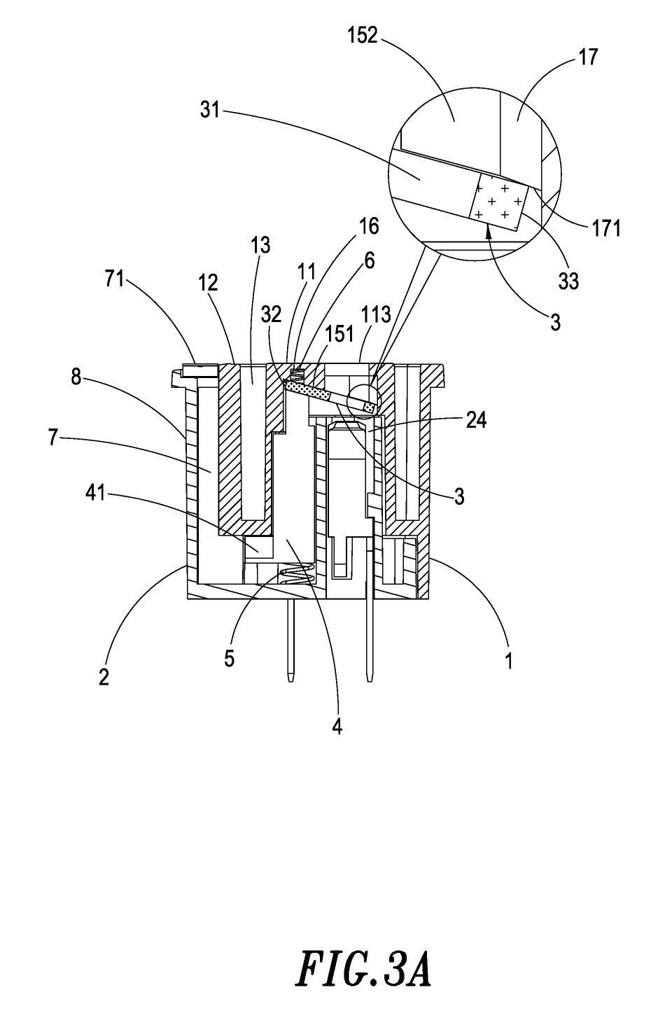

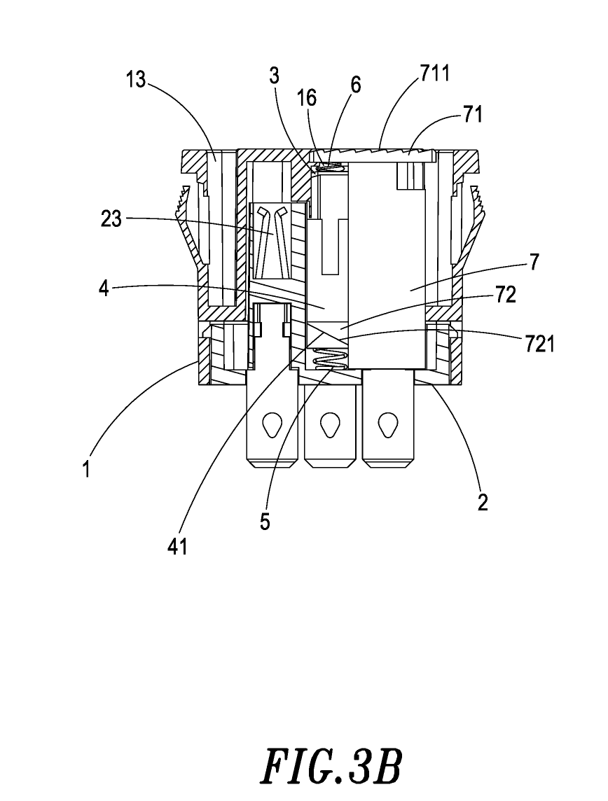

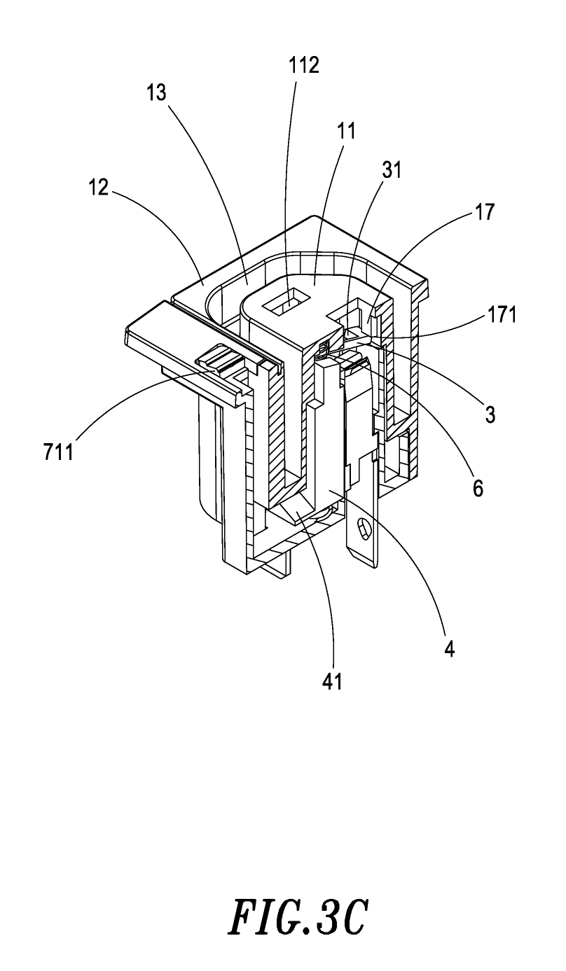

Refer initially to FIGS. 1, 2, 3A, 3B and 3C. It can be seen from the Figures that the present invention mainly comprises an external cover 1, a base seat 2, a positioning plate 3, an abutting element 4, an elastic body 5, a release element 6, a control element 7 and a control element fixation structure 8.

In addition, the external cover 1 has a socket panel 11 and an outer frame plane 12, in which a ring-shaped groove 13 is formed between the socket panel 11 and the outer frame plane 12, and the socket plane 11 includes a fire wire insertion hole 111, an earth wire insertion hole 112 as well as a neutral wire insertion hole 113.

Moreover, an accommodation groove 14 extends on the inner wall plane of the socket panel 12 in the external cover 1, the accommodation groove 14 has two corresponding long sidewall planes 141 and short sidewall planes 142, the long sidewall planes 141 are formed by respective downward extensions individually from the lateral edge of the live wire insertion hole 111 and the earth wire insertion hole 112 such that the accommodation groove 14 is located between the live wire insertion hole 111 and the earth wire insertion hole 112, while the neutral wire insertion hole 113 is communicatively connected to the accommodation groove 14, and the length and the width of the accommodation groove 14 are both greater than the neutral wire insertion hole 113; also, a corresponding first inclined block 151 extends respectively from the farthest edge of the bottom part on the long sidewall plane 141 close to the neutral wire insertion hole 113, and a corresponding second inclined block 152 respectively extends from the long sidewall plane 141 on the other side remote from the neutral wire insertion hole 113, and the length that the first inclined block 151 extends downwards from the socket panel 11 is smaller than the second inclined block 152; in addition, a stopper 17 is installed on the short sidewall plane 142 close to the neutral wire insertion hole 113 while the plane at one end of the stopper 17 remote from the socket panel 11 is an inclined plane 171, and the stopper 17 is positioned between the two second inclined blocks 152; further, a positioning space 16 for abutting and accommodating an end of the release element 6 is configured in the accommodation space 14, and is located between the live wire insertion hole 111 and the earth wire insertion hole 112.

Furthermore, the positioning plate 3 is made of a metallic material, an opening 31 is set up thereon and eccentrically configured; in this way, the positioning plate 3 can be accommodated into the accommodation groove 14 of the external cover 1 so that the two end edges of the positioning plate 3 can respectively abut the surfaces of the first inclined block 151 and the second inclined block 152; since the length of the first inclined block 151 is smaller than the second inclined block 152, the positioning plate 3 is thus slantingly installed thereby forming a high edge 32 and a low edge 33, and the opening 31 is close to the low edge 33; besides, the high edge 32 is remote from the neutral wire insertion hole 113, the low edge 33 is close to the neutral wire insertion hole 113, and the edge of the low edge 33 contacts the inclined plane 171 of the stopper 17; additionally, the opening 31 in the positioning plate 3 corresponds to the neutral wire insertion hole 113 of the socket panel 11, and the positioning plate 3 is placed within the accommodation groove 14 such that the positioning plate 3 can be separated from the live wire insertion hole 111 and the earth wire insertion hole 112 by means of the two long sidewall planes 141 in the accommodation groove 14.

Moreover, the other end of the release element 6 abuts the surface of the positioning plate 3 close to the high edge 32; in the present embodiment, the release element 6 may be a spring, and can be kept in a state of elastic force storage under the normal condition (i.e., the positioning plate 3 is in a tilted state); also, the release element 6 is by no means limited to a spring, but may be an elastic plate or any other elastic body.

Meanwhile, the base seat 2 can be combined with the external cover 1, the base seat 2 includes a base stage 21, a fire wire power jack 22, an earth wire power jack 23 and a neutral wire power jack 24, in which the fire wire power jack 22, the earth wire power jack 23 and the neutral wire power jack 24 respectively correspond to the fire wire insertion hole 111, the earth wire insertion hole 112 and the neutral wire insertion hole 113 of the socket panel 11; in addition, a combination space 25 is configured between the fire wire power jack 22 and the earth wire power jack 23, and connected in communication to the base stage 21.

Also, a positioning space 42 is configured at the bottom end of the abutting element 4 and internally combined with the elastic body 5, and the other end of the elastic body 5 extends out from the bottom end of the abutting element 4 in the normal state (i.e., elastic force release state), and an upward inclined plane 41 is set up on one side close to the bottom end; besides, the abutting element 4 is combined in the combination space 25 of the base seat 2 such that the other end of the elastic body 5 abuts the base stage 21 of the base seat 2, while the top 43 of the abutting element 4 abuts the high edge 32 of the positioning plate 3 thereby allowing the positioning plate 3 to be positioned inside the accommodation groove 14 and stably kept in the inclination state; in the present embodiment, the top end of the abutting element 4 may be configured as having an inclined plane shape so as to more stably maintain the positioning plate 3 in the high-low inclination state.

Moreover, because the elastic force in the elastic body 5 is greater than the release element 6, in the normal state (i.e., the positioning plate 3 is obliquely placed), the first elastic body 5 is in the non-compression state (i.e., elastic force release state), and since the elastic force of the release element 6 is less than the first elastic body 5, the release element 6 will be held in the compression state.

In addition, the aforementioned elastic body 6 may be also a spring or elastic plate or any other elastic component.

The control element fixation structure 8 has a standing plate 81, a control stage 82 is set up over the standing plate 81, and a push button movement groove 83 is configured on the control stage 82; the standing plate 81 can be fixedly connected to the base seat 2 so that the control element fixation structure 8 can be positioned on one side of the base seat, thus causing the control stage 82 to be located on one side of the outer frame plane 12 on the external cover 1, in which one side of the push button movement groove 83 is the lockup position 831, while the other end the release position 832; additionally, the control element fixation structure 8 may be integrally injection formed with the base seat, but it is certainly not limited thereto.

Besides, the top end of the control element 7 has a push button 71 whose surface includes anti-skid patterns 711, and a slide block 72 is installed on one side of the bottom end in the control element 7, the bottom plane of the slide block 72 is a downward inclined face 721, while this inclined face 721 is reversely installed with respect to the inclined plane 41 on the bottom side of the abutting element 4. In this way, the control element 7 can be combined onto the control element fixation structure 8 such that the push button 71 is placed within the push button movement groove 83, while the inclined face 721 of the slide block 72 can cling to the inclined plane 41 at the bottom end of the abutting element 4. Hence, when the push button 71 moves horizontally, the inclined face 721 on the bottom side of the push button 71 can move on the inclined plane 41 at the bottom end of the abutting element 4, and since the two inclined plane/face are reversely installed, the abutting element 4 can move down a course due to the movement of the push button 71 as well as the guidance from the inclined face 721, so the push button 7 and the abutting element 4 can exhibit different movement directions.

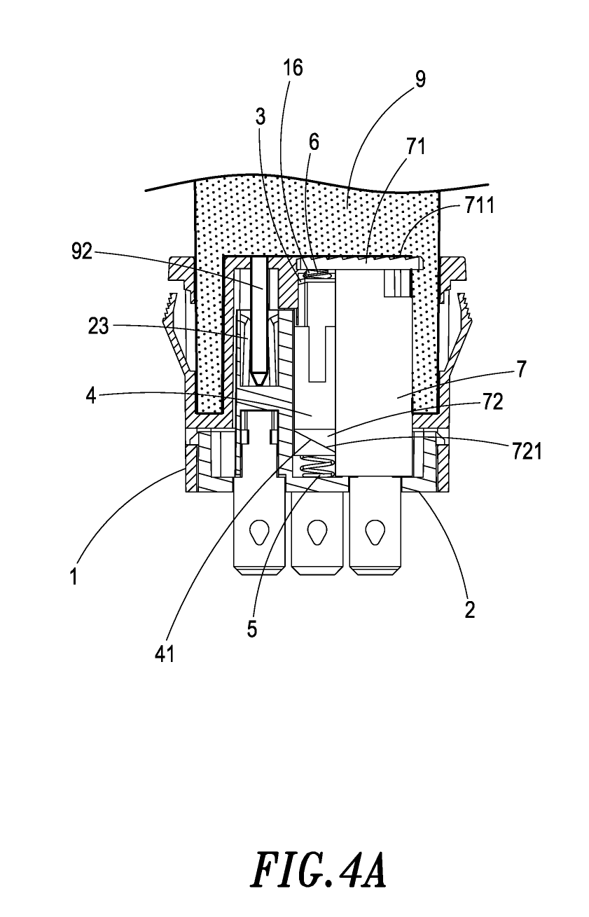

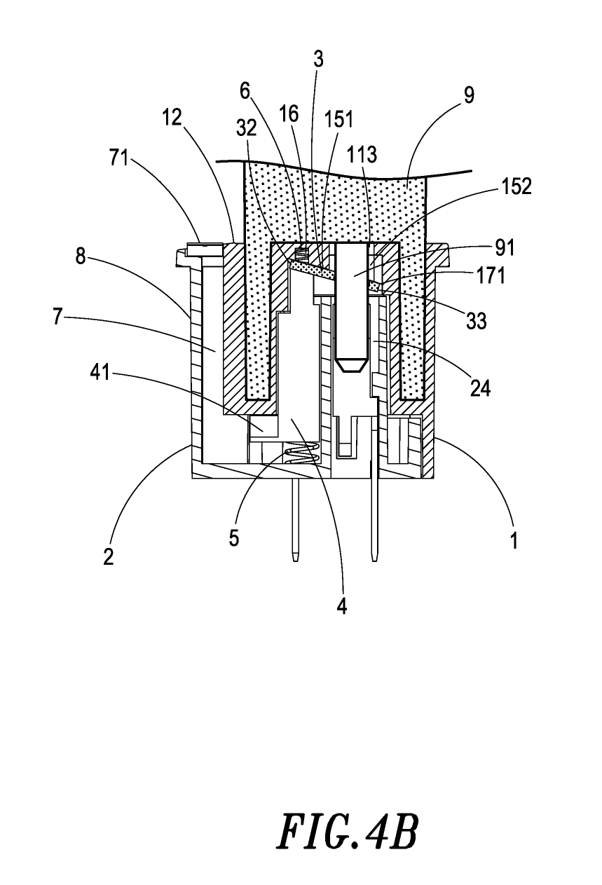

As shown in FIGS. 4A and 4B, the push button 71 is set to the lockup position 831, and, after inserting an electric power plug 9 into the live wire insertion hole 111, earth wire insertion hole 112 and neutral wire insertion hole 113 on the socket panel 11 of the external cover 1 (it should be noticed that the cross section of the electric power plug 9 exhibits a “∩” shape, so the external sides of the electric power plug 9 will be inserted into the ring-shaped groove 13), the live wire power insertion prong (not shown), earth wire power insertion prong 92 and neutral wire power insertion prong 91 on the electric power plug 9 can be respectively inserted into the live wire power jack 22, earth wire power jack 23 and neutral wire power jack 24 thereby conducting AC electric power. Seeing that the positioning plate 3 is separated by the long sidewall planes 141 of the accommodation groove 14, the live wire power insertion prong and earth wire power insertion prong of the electric power plug 9 will not contact the positioning plate 3 in order to prevent dangerous accidents such as short circuit problems. Upon inserting the neutral wire power insertion prong 113, the insertion force is greater than the force in the elastic body 5, so the abutting element 4 is pressed down by this force, resulting in pushing down the high edge 32 of the positioning plate 3 by the release element 6, thus that the positioning plate 3 moves to a horizontal position and the neutral wire power insertion prong 91 can be inserted into the neutral wire power jack 24 via the opening 31 of the positioning plate 3; after insertion, the abutting element 4 can bring, by means of the elastic force from the elastic body 5, the high edge 32 of the positioning plate 3 to move up thereby allowing the positioning plate 3 to return to its inclination state once again. At the same time, the neutral wire power insertion prong 91 can be simultaneously inserted into the opening 31 of the positioning plate 3 because the size of the neutral wire power insertion prong 91 in the electric power plug 9 is smaller than the opening 31 of the positioning plate 3. Although the opening 31 is greater than the neutral wire power insertion prong 91, since the positioning plate 3 is obliquely configured, the two ends of the opening 31 may respectively clamp the two ends of the neutral wire power insertion prong 91 so that the low edge 33 of the positioning plate 3 contacts the inclined plane 171 of the stopper 17. As such, upon pulling out the electric power plug 7 from the socket panel 11, the edge on the low edge 33 of the positioning plate 3 can be blocked by the inclined plane 171 of the stopper 17 so as to keep in the inclination state, thus further stably snapping the neutral wire power insertion prong 91 in position so the electric power plug 9 may not be pulled out from the socket panel 11.

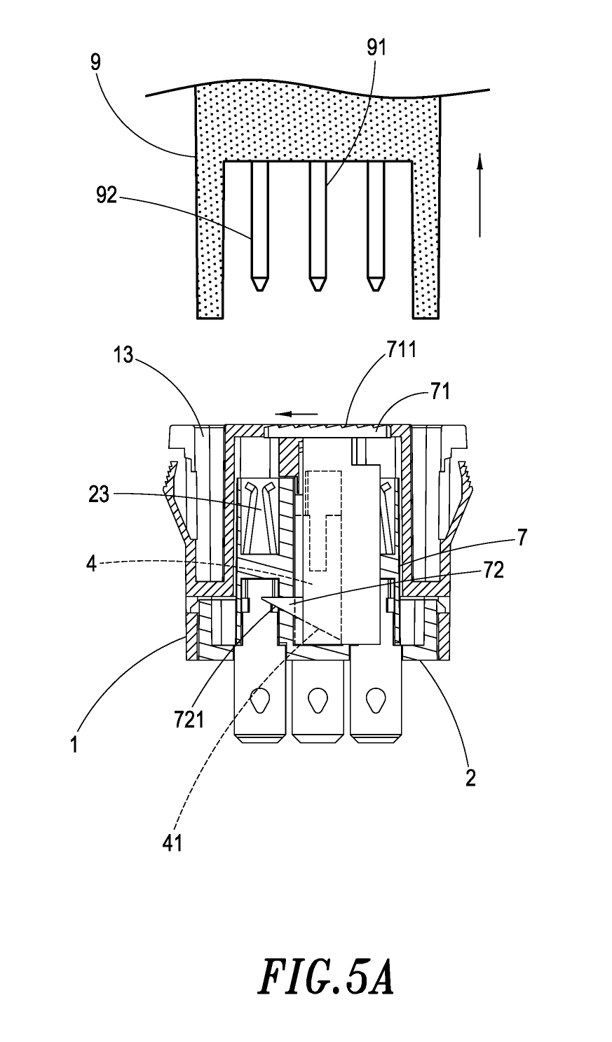

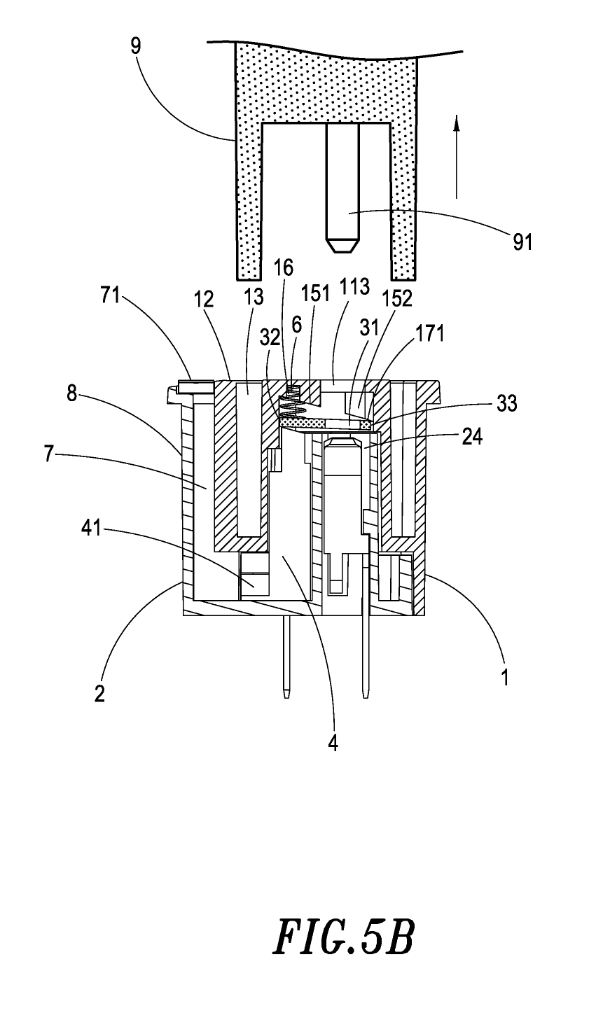

Upon releasing the electric power plug 9, as shown in FIGS. 5A and 5B, the push button 71 of the control element 7 can be horizontally pushed and moved from the lockup position 831 to the release position 832, and in the course of this horizontal movement of the push button 71, the inclined face 721 at the bottom side thereof can move on the inclined plane 41 of the abutting element 4, thereby further pushing down the abutting element 4 so as to generate elastic force by compressing the elastic body 5. At this moment, the two ends of the opening 31 in the positioning plate 3 are still snapped upon the neutral wire power insertion prong 91, and due to the downward movement of the abutting element 4, the high edge 32 of the positioning plate 3 still has space for downward movement thus allowing the release element 6 to transform from the compression state to the elastic force release state and to push down the high edge 32 of the positioning plate 3. Then, because the low edge 33 of the positioning plate 3 contacts the inclined plane 171 of the stopper 17 and the high edge 32 and low edge 33 of the positioning plate 3 are not fixed, when the high edge 32 moves down, the edge of the low edge 33 will be guided by the inclined plane 171 of the stopper 17 to become slightly deviated such that the positioning plate 3 can be driven into the horizontal state thereby allowing to successfully remove the electric power plug 9.

As such, in comparison with other conventional technologies, the socket structure according to the present invention desirably provides the following advantages:

1. The present invention allows to abut and hold an electric power plug, once inserted, thereby preventing it from being pulled out and falling off, so it is possible to overcome dangerous situations like power break and accidental electric shock issues caused by plug falloff.

2. The present invention uses a push button to move horizontally thus further controlling the abutting element to move downwards thereby allowing the release element to push and locate the positioning plate to a horizontal state; accordingly, since the movement directions of the push button and the abutting element differ, the user can operate the device with only one hand; that is, after pushing the push button using one hand, the same hand can pull out the electric power plug in order to resolve the issue that, typically, it requires a person's one hand to press down the button, and the other hand to unplug from the power socket, so the present invention can be utilized more conveniently the conventional products.

3. Seeing that the inclined plane at the bottom end of the abutting element in the present invention is abutted by the inclined face at the bottom end of the control element, the positioning plate can be stably maintained in the high-low inclination state, such that the positioning plate can firmly and stably snap the neutral wire power prong of the electric power plug in position, so the electric power plug may not be pulled out from the socket panel when the push button is set up in the lockup state.

It should be noticed that, although the present invention has been disclosed through the detailed descriptions of the aforementioned embodiments, such illustrations are by no means used to restrict the scope of the present invention; that is, skilled ones in relevant fields of the present invention can certainly devise any applicable alternations and modifications after having comprehended the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A socket structure, comprising:
an external cover, having a socket panel and a case of an outer frame plane, in which a ring-shaped groove is formed between the socket panel and the outer frame plane, and the socket plane includes a fire wire insertion hole, an earth wire insertion hole and a neutral wire insertion hole;
a positioning plate, installed inside the outer cover in a high-low inclination configuration, in which the two ends thereof respectively form a high edge and a low edge such that, when the positioning plate is in an inclination state, the neutral wire power insertion prong of an electric power plug can be fixedly snapped, while, in a horizontal state, the neutral wire power insertion prong can be released from the inside of the positioning plate;
a release element, with one end thereof abutting the inner wall plane of the socket panel, while the other end abutting the surface of the high edge on the positioning plate, and exhibiting a state of elastic force storage;
a base seat, including a live wire power jack, an earth wire power jack and a neutral wire power jack, in which the socket seat can be combined with the external cover such that the live wire power jack, the earth wire power jack and the neutral wire power jack respectively correspond to the live wire insertion hole, the earth wire insertion hole and the neutral wire insertion hole on the socket panel, and a combination space is configured on the base seat;
an abutting element, in which an upward inclined plane is configured on one side near the bottom end of the abutting element, and an elastic body is combined with the bottom end; the abutting element can be jointed to the combination space in the base seat such that the other end of the elastic body abuts the base seat, while the top end of the abutting element abuts the high edge of the positioning plate, so that the positioning plate demonstrates a high-low inclination configuration due to such abutments by means of the abutting element; additionally, the elastic force in the elastic body is greater than the release element;
a control element fixation structure, which includes a standing plate, and a control stage is set up on the standing plate and has a push button movement slot; in which the standing plate is fixedly connected to the base seat such that the control element fixation structure can be firmly placed on one side of the base seat and accordingly the control stage is located on one side of the outer frame plane in the external cover, and also one end of the push button movement slot indicates a lockup position, while the other end a release position;
a control element, in which the top end thereof is a push button, a slide block is installed on one side of the bottom end, the bottom plane of the slide block has a downward inclined face which is inclined-plane-reversely configured with respect to the bottom plane of the abutting element; and the control element is combined onto the control element fixation structure such that the push button is located within the push button movement slot while the inclined face of the slide block can movably cling to the inclined plane on the bottom end of the abutting element; accordingly, when the push button moves horizontally, the inclined face at the bottom end of the push button can move on the inclined plane at the bottom end of the abutting element, and since such two inclined plane/face are reversely installed with respect to each other, the abutting element can move down a course due to the movement of the push button as well as the guidance from the inclined face.

2. The socket structure according to claim 1, wherein an accommodation groove extends from the inner wall of the socket panel and connected to the neutral wire insertion hole, and the length and width of the accommodation groove are both greater than the neutral wire insertion hole; also, a corresponding first inclined block extends respectively from the farthest edge of the bottom part on the long sidewall plane close to the neutral wire insertion hole, and a corresponding second inclined block respectively extends from the long sidewall plane on the other side remote from the neutral wire insertion hole, and the length that the first inclined block extends downwards from the socket panel is smaller than the second inclined block; and the accommodation groove is mainly for accommodating the positioning plate in order to make the positioning plate exhibit a high-low inclination configuration by means of the first inclined block and the second inclined block.

3. The socket structure according to claim 2, wherein a stopper extends from the short sidewall plane close to the neutral wire insertion hole, the end plane of the stopper remote from the socket panel is an inclined plane, and the stopper is located between the two first inclined blocks.

4. The socket structure according to claim 1, wherein the positioning plate is made of a metallic material, with an opening configured thereon, and the opening is eccentrically configured and corresponds to the neutral wire insertion hole.

5. The socket structure according to claim 1, wherein the release element is a spring or an elastic plate or rubber elastic body or plastic elastic body.

6. The socket structure according to claim 1, wherein the base seat includes a base stage, and the base stage is connected in communication with the combination space such that one end of the elastic body abuts the base stage.

7. The socket structure according to claim 1, wherein the elastic body is a spring, an elastic plate or rubber elastic body or plastic elastic body.

8. The socket structure according to claim 1, wherein the control element fixation structure and the base seat are integrally manufactured.
